(19) United States
(12) Patent Application Publication
(10) Pub. No.: US 2012/0127557 A1
(43) Pub. Date: May 24, 2012

(54) APPARATUS AND METHOD FOR IRRADIATING A MEDIUM

(75) Inventor: Takahiro Masumura, Tuscon, AZ (US)

(73) Assignee: CANON KABUSHIKI KAISHA, Tokyo (JP)

(21) Appl. No.: 12/950,941

(22) Filed: Nov. 19, 2010

(51) Int. Cl. G02B 26/00

(52) U.S. Cl. 359/291

(57) ABSTRACT

An apparatus includes an irradiating unit, a spatial light modulator configured to modulate a wavefront of an electromagnetic wave, a device configured to receive a signal from a position of the medium by irradiating the electromagnetic wave, and a controller configured to control the spatial light modulator based on the received signal so that the irradiated electromagnetic wave with the modulated wavefront focuses on the position in the medium.

### BACKGROUND OF THE INVENTION

1. Field of the Invention

The present invention relates to an apparatus and a method for irradiating a medium.

2. Description of the Related Art

Light scattering is one of the essential matters that can obstruct and even prevent viewing inside of a medium where scattering processes are dominant. This is because the scattered light does not propagate in a straight line through the medium, with the random paths of the scattered light causing the loss of directionality of the light as well as information associated therewith. Thus, it can be difficult to extract detailed internal information about the medium in which such scattering occurs via the detection of the scattered or diffused visible light. For example, in medical applications that deal with biological tissues, the scattering that occurs in passing light through the tissues may make it difficult to obtain internal information via detection of the scattered light.

In addition, there is also increasing demand to be able to concentrate light energy at a target position in a scattering medium to allow for treatment of abnormal tissue in photodynamic therapy, as well as to achieve unique and promising functions that were heretofore unobtainable in intentionally disordered random materials.

The ability to focus light at a point inside of or through a scattering medium has not been achieved until fairly recently. However, in recent years, a technique has been proposed which optimizes a wavefront of incident light to suppress the scattering effect.

In a paper, I. M. Vellekoop and A. P. Mosk, “Focusing coherent light through opaque strongly scattering media”, Opt. Lett. Vol. 32, No. 16, pp. 2309-2311 (2007), a technique to control an incident wavefront with a spatial light modulator and an optimization algorithm is disclosed.

Since elastic optical scattering is a deterministic and time-reversible process, it is possible to focus light through the scattering medium by optimizing the wavefront of the incident light. The method as disclosed in the paper utilizes this feature, which can be effective in focusing light and enhancing a light intensity at a plane behind the scattering medium.

Their method described therein is only capable of focusing light at a region just behind the scattering medium, where the detector that monitors the light intensity to be used for the optimization is located. Therefore, as described therein, the method is not capable of focusing light arbitrarily at any specific point inside the scattering medium.

In addition, Vellekoop et al. (I. M. Vellekoop, E. G. van Putten, A. Lagendijk and A. P. Mosk, “Demixing light paths inside disordered metamaterials”, Opt. Express, Vol. 16, No. 1, pp. 67-80 (2008)) further suggests that it may be possible to use the wavefront optimization method described therein to illuminate a specific point where a fluorescent probe is situated inside the scattering medium if a fluorescent probe is used.

However, the focusing volume at the specific point in the medium may be restricted by the position or the size of the fluorescent probe that is used and, therefore, it might be difficult to control the position or size of the focusing volume arbitrarily in the medium. In addition, when the medium is living human tissue, the fluorescent probe might be more or less invasive to the tissue.

### SUMMARY OF THE INVENTION

According to an aspect of the present invention, an apparatus includes an irradiating unit, including an electromagnetic wave source which emits an electromagnetic wave, configured to irradiate a medium with the electromagnetic wave; a spatial light modulator configured to modulate a wavefront of the electromagnetic wave; an ultrasound device configured to receive a photo-acoustic signal from a position of the medium by irradiating the electromagnetic wave; and a controller configured to control the spatial light modulator based on the received photo-acoustic signal so that the irradiated electromagnetic wave with the modulated wavefront focuses on the position in the medium.

According to another aspect of the present invention, an apparatus includes an irradiating unit, including an electromagnetic wave source which emits an electromagnetic wave, configured to irradiate a medium with the electromagnetic wave; a spatial light modulator configured to modulate a wavefront of the electromagnetic wave; an ultrasound device configured to apply ultrasound to a position of the medium where a frequency of the electromagnetic wave is shifted; a detector configured to detect the electromagnetic wave whose frequency is shifted; and a controller configured to control the spatial light modulator based on the detected electromagnetic wave so that the irradiated electromagnetic wave with the modulated wavefront focuses on the position in the medium.

According to another aspect of the present invention, an apparatus includes a spatial light modulator configured to modulate a wavefront of an electromagnetic wave to be applied to a medium, by monitoring a first signal from the medium, so that the applied electromagnetic wave focuses on a position of the medium; an applying unit configured to apply the electromagnetic wave with the modulated wavefront to the medium; a detector configured to detect a second signal, which is of the same type as the first signal, from the position of the medium; and an image generating unit configured to generate an image based on the detected second signal.

According to another aspect of the present invention, an apparatus comprises a spatial light modulator configured to modulate a wavefront of an electromagnetic wave to be applied to a medium, by monitoring at least one of a photo-acoustic signal and an acousto-optic signal from the medium, so that the applied electromagnetic wave focuses on a position of the medium; an applying unit configured to apply the electromagnetic wave with the modulated wavefront to the medium; a first unit configured to detect the photo-acoustic signal from the position of the medium; a second unit configured to detect the acousto-optic signal from the position of the medium; and an image generating unit configured to generate an image based on the detected the photo-acoustic and the acousto-optic signals.

Further features of the present invention will become apparent from the following description of exemplary embodiments with reference to the attached drawings.

### BRIEF DESCRIPTION OF THE DRAWINGS

FIG. 1 illustrates an apparatus described in an exemplary embodiment for irradiating.

FIG. 2 illustrates an exemplary operation flow used in the first embodiment.

FIG. 3 illustrates multiple light focusing points in a scattering medium.

FIG. 4 illustrates an apparatus of an exemplary third embodiment for irradiating.

FIG. 5 illustrates another exemplary operation flow used in the third embodiment.

### DESCRIPTION OF THE EMBODIMENTS

Embodiments according to the present invention will be described below with reference to the attached drawings.

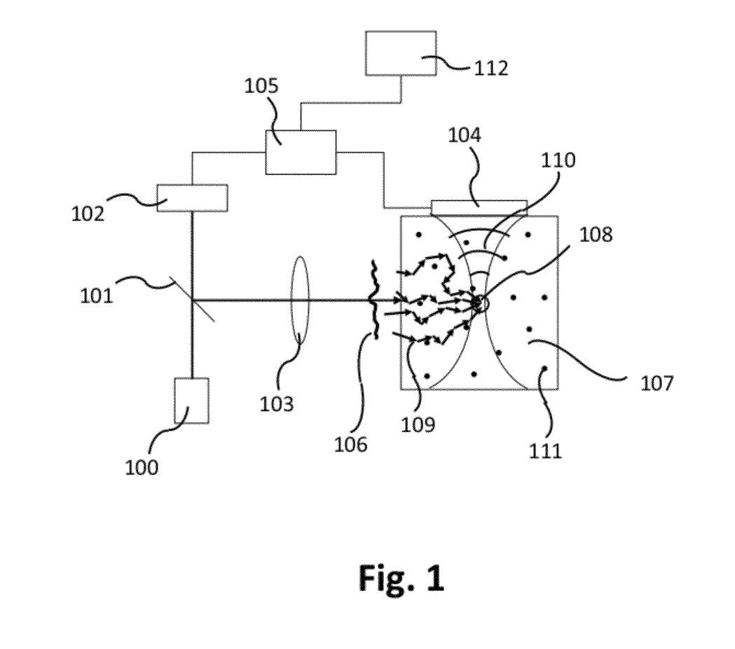

FIG. 1 illustrates an exemplary configuration of an apparatus to irradiate a medium with the irradiating apparatus as a first embodiment. In the first embodiment, wavefront control may be executed by using a photo-acoustic signal.

A light source 100 can emit light pulses. Typically the pulse width is several nanoseconds to cause photo-acoustic effect, and the wavelength of the electromagnetic wave emitted by the light source 100 can range from visible light to near infrared light, such as 360 nm to 2500 nm. The emitted light transmits through a mirror 101 and impinges onto a spatial light modulator (SLM) 102, such as a liquid crystal on silicon (LCOS). The SLM 102, controlled by a control unit 105, changes phases of a wavefront of the light according to an optimization algorithm performed by the control unit 105. This spatially modulated wavefront 106 is led to a scattering medium 107 including scattering particles 111 through a lens system 103. On the other hand, the control unit 105 can set properties of a local region 108 such as a position, a volume size or a shape thereof by using an ultrasound device 104. The ultrasound device can be configured to receive an ultrasonic wave as a detector and also send the ultrasonic wave.

Here, the scattering medium 107 can be, for example, a biological tissue or any other turbid medium or disordered material.

In the scattering medium 107, the light suffers multiple scattering and some portion of the light may be absorbed in the local region 108 at a position in the medium 107. The temperature of the local region 108 may increase by the light absorption. Due to the expansion of the volume of this local region 108, an acoustic wave (photo-acoustic signal) 110 is generated. According to the equation (1), the photo-acoustic signal P is proportional to the local absorption coefficient μₐ and light fluence rate Φ at that point.

P=ΓμₐΦ (1)

In the equation (1), Γ is Grueneisen coefficient (heat-acoustic conversion efficiency).

Therefore, the higher the fluence rate, the larger the photo-acoustic signal. Typically Γ and μₐ may be position dependent parameters but constant in time. Hence, the change of the photo-acoustic signal during the optimization procedure described below may be linearly related to the change of the light fluence at that region 108. Instead of the light signal being directly monitored, the photo-acoustic signal can be monitored to confirm a focusing effect at the local region 108 since that photo-acoustic signal clearly originated from the region 108 where the ultrasound is focused. Therefore, it is possible to monitor the light intensity at a specific position inside the scattering medium.

The generated acoustic wave 110 is received by the ultrasound device 104. The ultrasound device 104 can include, for example, a linear array probe. The local region 108 may be set at a desired position in the scattering medium 107 by electronic focusing the array probe. Alternatively, the region 108 may be set at a desired position by mechanically scanning an ultrasound transducer, including a circular concave ultrasound transducer or a transducer including an acoustic lens. As such a transducer, a transducer using a piezoelectric phenomenon, a transducer using resonance of light, or a transducer using a change in capacity is available.

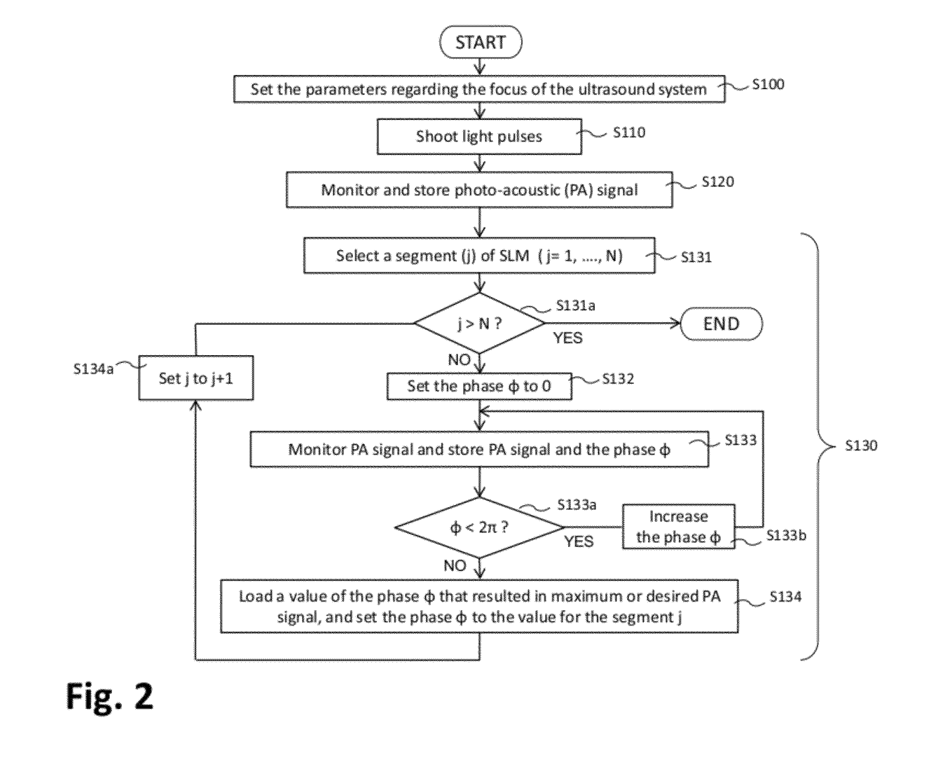

FIG. 2 shows an exemplary operation flow of this first embodiment. At first, the parameter conditions regarding a focus position defined by the ultrasound device 104, such as the position or the size of the local region 108, is set at S100, and the light source 100 can shoot light pulses at S110. The photo-acoustic signal generated at the region 108 can be selectively received by the ultrasound device 104 and monitored and stored in a memory. The monitoring and storing can be executed by the control unit 105 at S120.

After the control unit 105 has stored the information about the intensity of the photo-acoustic signal, the control unit 105 controls the SLM 102 and starts an optimization process at S130. The optimization process S130 consists of several sub-flows. At S131, one of the segments on the SLM 102 is controlled by the control unit 105 to change its phase of incoming light. Here, the segment of the SLM 102 may include a single pixel or a plurality of pixels on the SLM 102. The configuration of this segmentation may also be determined at S100. At S131a, it is determined if processing has been performed for all of the segments. If processing has been performed for all of the segments (j>N is YES), processing of FIG. 2 ends. If processing has not been performed for all of the segments, at S132, the phase φ of the current segment j being processed is set to 0. The photo-acoustic signal for the segment at the currently set phase φ is monitored and stored with the phase φ at S133. At S133a, it is determined if all phases from 0 to 2π have been processed for the current segment j. If processing for all phases between 0 and 2π has not been performed for the current segment (phase φ<2π is YES), at S133b, the phase for the current segment is increased, for example, the phase can be continuously or discretely changed from 0 to 2π. After increasing the phase φ, processing returns to S133 where the photo-acoustic signal and the phase for the segment at the currently set phase φ is monitored and stored. When processing for all phases between 0 and 2π has been performed for the current segment (phase φ<2π is NO), at S134, the control unit 105 picks up the phase that generated the largest photo-acoustic signal during the step S132 and S133, and assigns the phase at the segment j. Processing then moves to S134a to repeat the above described processing for the next segment j. This process is repeated until all of the segments on the SLM 102 are completed (segment j>N is YES at S131a). According to FIG. 2, in the manner described above, each segment may be treated consecutively and independently. At the end of S130 (segment j>N is YES at S131a), the optimized phase distribution on the SLM 102 to be able to focus on the local region 108 can be created.

In the case of using the biological tissues, Γ or μₐ might change during the optimization process due to the environment change such as blood flow change, or temperature change and so on. To reduce the influence of these fluctuations of Γ or μₐ, calibration can be executed as necessary. In order to calibrate these fluctuations, the system may calculate the following equation (2) between the optimization of each pixel j and j+1 on the SLM at S130.

$$\begin{matrix}\frac{{P}_{j + 1} ( r ) - {P}_{j} ( r )}{{P}_{j} ( r )} = \frac{{Γ}_{j + 1} ( r ) {μ}_{aj + 1} ( r ) {Φ}_{j + 1} ( r ) - {Γ}_{j} ( r ) {μ}_{aj} ( r ) {Φ}_{j} ( r )}{{Γ}_{j} ( r ) {μ}_{aj} ( r ) {Φ}_{j} ( r )} \\ \approx \frac{{Γ}_{j} ( r ) {μ}_{aj} ( r ) ( {Φ}_{j + 1} ( r ) - {Φ}_{j} ( r )}{{Γ}_{j} ( r ) {μ}_{aj} ( r ) {Φ}_{j} ( r )} \\ = \frac{{Φ}_{j + 1} ( r ) - {Φ}_{j} ( r )}{{Φ}_{j} ( r )} \\ = \frac{Δ {Φ}_{j + 1} ( r )}{{Φ}_{j} ( r )}\end{matrix} \qquad ( 2 )$$

In the equation, r is the position in the medium. The light fluence rate Φ will change by adjusting the phase of each pixel on the SLM. However, it can be assumed that the change of Γ or μₐ during the phase optimization process can be so small that it can be negligible. Eventually the change of the photo-acoustic signal can be seen as a change of the light fluence rate at that specific volume.

The local region 108 in the medium 107, where light focus effect occurs in the scattering medium, may be set at an arbitrary or desired position or size in the medium 107.

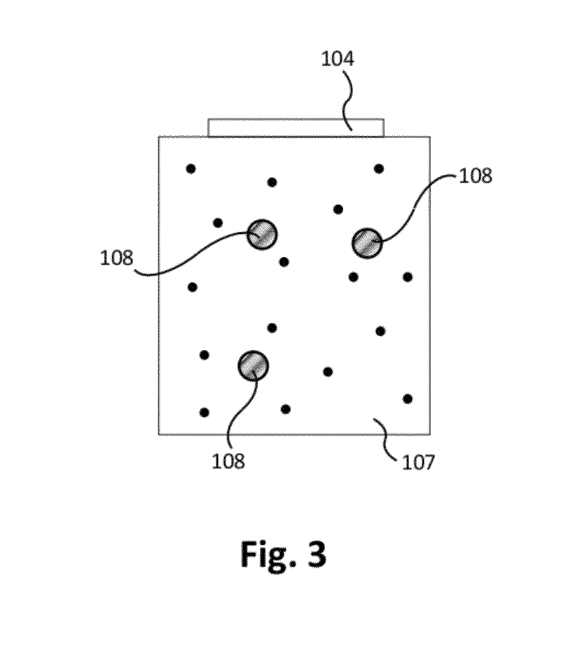

Furthermore, a plurality of the local regions 108 may be set in the scattering medium 107 by accessing the photo-acoustic signals at those local regions at the same time by using electronic focusing of the ultrasound device 104 (FIG. 3). During step S130, those regions as multiple focus points may be monitored, and those photo-acoustic signals may be enhanced simultaneously by adjusting the phases of the segments.

The diagram illustrating an exemplary configuration is the same as shown in FIG. 1. As already explained, according to the operation flow shown in FIG. 2, the SLM 102 is optimized to generate optimized wavefront to focus on the local region 108 defined arbitrarily in the scattering medium 107.

The photo-acoustic signal is measured again with the optimized wavefront. Since most of the light energy concentrates at this local region 108, the ultrasound device 104 may detect photo-acoustic signals with high signal to noise ratio (SNR) to form a high quality image around this region.

An image generating process can follow the process. An image generating unit, which may be included in the control unit 105 or connected to the control unit 105, may reconstruct a three-dimensional image of the local region 108 using the data obtained from the ultrasound device 104. The image generating unit can map an absorption signal obtained by photo-acoustic measurement in accordance with the position of the local region 108 where the incident light focuses. The image can be displayed on a display device 112. In this embodiment, the wavefront control to irradiate a specified region by using the SLM is executed by monitoring photo-acoustic signal as a first kind of signal, and an imaging process to form an image of the specified region is also executed by detecting a photo-acoustic signal as a second signal which is of the same kind as the first signal.

Alternatively, it may be possible to change the position of the local region 108 to other points and optimize the wavefront at each position to measure photo-acoustic signals.

Furthermore, the above-described process may be performed using a plurality of desired wavelengths of the laser source 100 to obtain functional information, such as a proportion of the constituents of the scattering medium 107, e.g., oxy-hemoglobin, deoxy-hemoglobin, water, fat, collagen and an oxygen saturation index of the medium 107, such as when the scattering medium 107 is a biological tissue for medical application.

Furthermore, it may be possible to add one more step before S100. That is, pulsed ultrasonic waves may be transmitted from the ultrasound device 104 and ultrasonic echoes, serving as reflected waves, may be received by the ultrasound device 104. This ultrasound echo measurement may be performed while the direction in which the pulse ultrasonic wave is transmitted is changed relative to the scattering medium 107, thus obtaining structural data regarding the inside of the scattering medium 107. The local region 108 can be set by taking advantage of the structural data obtained by the ultrasound echo measurement, for example, by setting at a position where a characteristic difference can be seen in the echo image.

By focusing light on the measurement region of the medium, it may be possible to enhance the measurement depth and SNR of photo-acoustic imaging. The following are hereby incorporated by reference in their entireties as though fully and completely set forth herein: U.S. Pat. No. 4,385,634 to Bowen, issued May 31, 1983, U.S. Pat. No. 5,840,023 to Oraevsky et al, issued Nov. 24, 1998, and U.S. Pat. No. 5,713,356 to Kruger, issued Feb. 3, 1998.

An irradiating apparatus and method according to a second embodiment of the present invention will be described. The diagram of this system is same as FIG. 1, but the light source 100 may have at least two different types of lasers including the pulse laser for generating photo-acoustic signals, as necessary. The irradiating apparatus can deliver light into a specific position in a disordered scattering material.

As already explained, according to the operation flow shown in FIG. 2, the SLM 102 is optimized to generate optimized wavefront to be able to focus light at the local region 108 defined arbitrarily in the scattering medium 107.

Once the phase of the SLM 102 has optimized, the light source can be changed from the pulse laser to a second laser that has relatively stronger power to deliver relatively high power to the specific volume 108, for example for the purpose of the therapy or treatment such as photodynamic therapy in biological tissues. The second laser as a light source is different power from the pulse laser used in the optimization process. Thus, many kinds of lasers can be applicable depending on the purpose of the therapy or treatment (e.g., femto second pulse to pico, nano, micro etc.). The light power of the second light source can be controlled depending on the treatment.

The optimized light beam 106 for therapy whose phase can be controlled by the SLM 102 can reach the local region 108 so as to deliver light energy at the tissue region where the treatment is needed. The position of the region 108 may be set by referring to other diagnostic results.

By using the second embodiment according to the present invention, it may be possible to deliver the high energy density of light efficiently to a specific point with less damage to other areas in the scattering medium 107.

The described embodiments can also be applied to fluorescence imaging which uses a chemical probe (molecules) to obtain biochemical information such as abnormality of the tissue, for example, by setting the local region to the point where the fluorescence probe is located. The optimization process for the wavefront of the irradiating light may be the same as already described above. If the location of the chemical probe is not certain, then the local region can simply be scanned to irradiate inside the scattering medium one position at a time. By focusing light at the position where the fluorescence probe is located, it may be possible to obtain high contrast images of the target, such as, for example, a tumor.

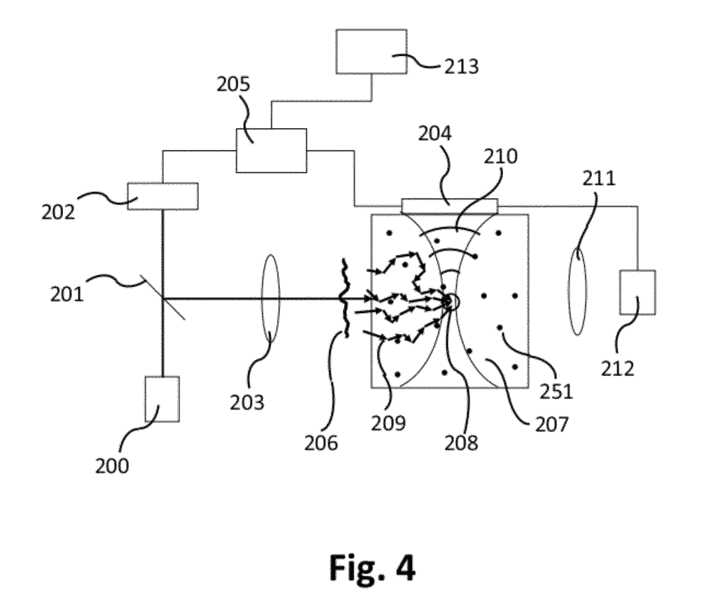

An irradiating apparatus and method according to a third embodiment of the present invention will now be described. FIG. 4 illustrates a third exemplary configuration of a system with the irradiating apparatus. In the third embodiment, the wavefront control may be executed by using frequency-shifted light signal (acousto-optic signal).

A light source 200 can emit light. Typically the light may be continuous-wave (CW), and the wavelength emitted by the light source 200 can range from visible light to near infrared light. The emitted light transmits through a mirror 201 and impinges onto a SLM 202, such as a liquid crystal on silicon (LCOS). The SLM 202, controlled by a control unit 205, changes phases of a wavefront of the light according to an optimization algorithm performed by the control unit 205. This spatially modulated wavefront 206 can be led to a scattering medium 207 through a lens system 203.

The control unit 205 sets properties of a local region 208 such as position, volume size or shape of an ultrasound system 204. The scattering medium 207 including scattering particles 251 is irradiated by focused ultrasound pulses at the local region 208, where the refractive index of the medium 207 is modulated and in addition, the displacement of the scatterers in the scattering medium 207 is induced with the frequency of the applied ultrasonic wave, used in a technique called acousto-optic imaging or ultrasound modulated tomography.

In the scattering medium 207, the light suffers multiple scattering and some portion of the light may enter the local region 208. Once the portion of the incident light 206 reaches the ultrasound irradiated volume at the position of the local region 208 in the medium 207, the optical phase of the light can be modulated by the frequency of the ultrasonic wave, and that causes frequency-shift of the light.

This frequency-shifted light can be detected by a photodetector system 212 through a collection lens system 211. As for the photodetector system 212, a single sensor such as a photomultiplier tube (PMT) or an avalanche photo diode (APD), can be used with typically, lock-in amplifier system or bandpass filter to monitor the frequency-shifted light intensity. Alternatively, a multi-sensor, such as a CCD or a CMOS, or area sensors with an image intensifier, or EMCCD (Electron Multiplying CCD) can be used to measure speckle contrast difference under conditions between ultrasound-on and ultrasound-off, which are related to the ultrasound modulation depth, to monitor the intensity of modulated light. Alternatively, a photodetector with photorefractive device or Fabry-Perot interferometer detection system can also be applicable to detect the frequency-shifted light.

The intensity of this modulated light depends on the original light intensity which reached this local volume 208 through multiple scatterings before getting modulated. The more the focus effect happens, the more the frequency-shifted light is generated. This frequency-shifted light signal (acousto-optic signal) can be used to monitor the light intensity at that local region 208 in the scattering medium 207 for the optimization processing because this modulated light clearly originates from the local region 208. Hence, the change of the acousto-optic signal during the optimization processing may be linearly related to the change of the light intensity at that local region 208.

The ultrasound device 204 transmits an ultrasonic wave 210 to create a focused local region 208 whose size and position may be determined a priori. It may be possible to radiate pulsed ultrasound to achieve small longitudinal focus volume. The pulse width of the ultrasound can be set depending on the size of the local region 208 and the speed of the ultrasonic wave 210 in the scattering medium 207. Furthermore, stroboscopic irradiation can be used, where the timing of the irradiation from the light source 200 may be synchronized to irradiate the medium 207 only during the time period when the ultrasound pulse locates the position to be focused. To set the region 208 at a position in the medium 207, a focused ultrasound may be employed.

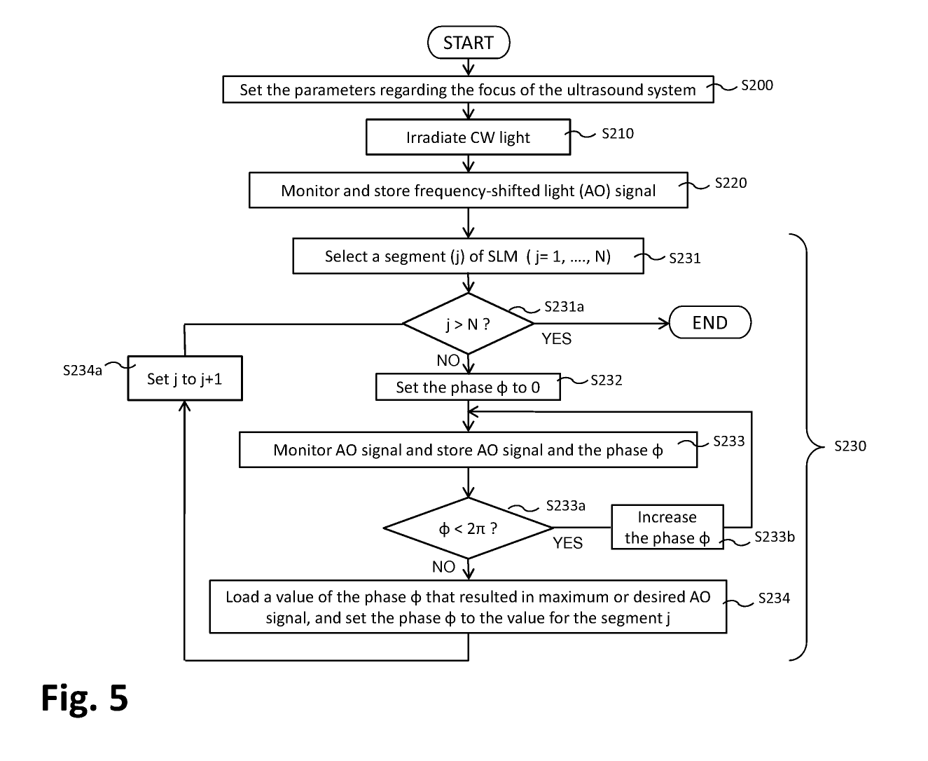

FIG. 5 shows an exemplary operation flow of this system. At first, the parameter conditions regarding the focus of the ultrasound device 204, such as the position or the size of the focus volume 208, is set at S200, and the light source 200 irradiates CW light at S210. The acousto-optic signal generated at the region 208 is selectively detected by the photodetector 212 and its signal intensity is monitored and stored in the memory by the control unit 205 at S220.

After the control unit 205 stores the intensity of the acousto-optic signal, the control unit 205 controls the SLM 202 and starts optimization process at S230. The process S230 consists of several sub-flows. At S231, one of the segments on the SLM 202 is controlled by the control unit 205 to change its phase. Here, the segment may be a single pixel, or a plurality of pixels on the SLM 202. At S231a, it is determined whether processing for all of the segments on the SLM 202 has been preformed. If processing for all of the segments has been performed (j>N is YES), processing of FIG. 5 ends. On the other hand, if processing for all of the segments has not been performed (j>N is NO), at S232, the phase of the segment is set to 0. At S233, the acousto-optic signal (AO signal) is monitored and stored with the phase φ. At S233a, it is determined whether the phase of the segment is less than 2π. If the phase of the segment is less than 2π, at S233b, the phase is increased. For example, the phase can be continuously or discretely changed from 0 to 2π. Processing then returns to S233. In this manner, the phase of the segment is consecutively changed from 0 to 2π and each time the acousto-optic signal (AO signal) is monitored and stored with the phase φ at S233. If at S233a it is determined that the phase is not less than 2π, at S234, the control unit 205 picks up the phase that produced the largest acousto-optic signal during the step S232 and S233, and assigns the phase at that segment. Then, at S234a, processing is set to repeat for the next segment so that the above-described process can be repeated until all of the segments on the SLM 202 are completed. Thus, each segment may be treated independently. At the end of S230, the optimized phase distribution on the SLM 202 to be able to focus at the local region 208 can be created.

Once the optimized wavefront is created, the acousto-optic signal is measured again with the optimized wavefront. Since the light energy concentrates at this focus volume 108, the photodetector 212 may detect acousto-optic signals with high SNR to form a high quality image around this region.

An image generating process may follow the measurement. An image generating unit, which may be included in the control unit 205 or connected to the control unit 205, may reconstruct a three-dimensional image using the above data. The image generating unit can map the acousto-optic signal which may be related to absorption signal or scattering signal in accordance with the position of the local region 208. The image can be displayed on a display device 213.

Alternatively, it may be possible to change the position of the region 208 to other points and optimize the wavefront at each position to measure acousto-optic signals. In this embodiment, the wavefront control to irradiate a specified region by using the SLM is executed by monitoring an acousto-optic signal as a first kind of signal, and imaging process to form an image of the specified region is also executed by detecting an acousto-optic signal as a second signal which is of the same kind as the first signal.

An apparatus and method according to a fourth embodiment of the present invention will be described below. This embodiment is a combination system, which comprises an acousto-optic system and a photo-acoustic system. The configuration of the combination system in this embodiment may be the same as that of in the third embodiment shown in FIG. 4. In addition, the light source unit 200 may be modified to emit different kinds of lights with at least two different lasers. One may be a laser for an acousto-optic system and the other may be a pulse laser for a photo-acoustic system. The lasers can be switched from one to the other.

According to flow shown in the FIG. 2 or FIG. 5, the optimized phase modulation can be generated by the SLM. The optimization can be executed at least by the process described in the first embodiment or the process described in the third embodiment. It may be executed by using both of the processes. After the optimization, the photo-acoustic signal (or the acousto-optic signal) can be measured again with the optimized wavefront. Furthermore, by switching the laser source, the acousto-optic signal (or the photo-acoustic signal) can also be measured with the optimized wavefront.

An image generating unit, which may be included in the control unit 205 or connected to the control unit 205, may reconstruct the three-dimensional image using both photoacoustic signal and acousto-optic signal. The image generating unit can map an absorption signal obtained by photo-acoustic measurement in accordance with the positions of the local region 208. In addition, an acousto-optic signal is used to generate a scattering distribution image in the same way. Since photo-acoustic image is sensitive to absorption, while acousto-optic image is sensitive to scattering, by combining both measurement results, absorption and scattering distribution images can be generated. Those images can be displayed on the screen of the display device 213.

Alternatively, during the optimization flow shown in FIG. 2, it may be possible to encounter a situation where the photo-acoustic signal is too weak to monitor for phase optimization due to the very low absorption at that ultrasound focus volume. In this situation, the system can change the light source from the pulse laser for photo-acoustic imaging to CW laser for acousto-optic. Moreover, the ultrasound device 204 can change its operation mode from a reception mode to a transmission mode in order to detect an acousto-optic signal, without changing the focusing setting used for the reception mode. And the operation flow shown in FIG. 5 may be performed. Since photo-acoustic signal may be used at relatively higher absorption area where the photoacoustic signal is larger, on the other hand, acousto-optics signal may be used at low absorption and higher scattering area where the photo-acoustic signal becomes lower while acousto-optics signal is larger. This sort of complementary method can be feasible in this system.

As has already been described, the embodiments according to the present invention can be applicable to a variety of optical imaging or therapy or apparatuses for the purpose of concentrating light at specific points, which may be controllable, inside the scattering medium.

While the embodiments according to the present invention have been described with reference to exemplary embodiments, it is to be understood that the present invention is not limited to the above described embodiments. The scope of the following claims is to be accorded the broadest interpretation so as to encompass all such modifications and equivalent structures and functions.

What is claimed is:

1. An apparatus comprising:
an irradiating unit, including an electromagnetic wave source which emits an electromagnetic wave, configured to irradiate a medium with the electromagnetic wave;
a spatial light modulator configured to modulate a wavefront of the electromagnetic wave;
an ultrasound device configured to receive a photo-acoustic signal from a position of the medium by irradiating the electromagnetic wave; and
a controller configured to control the spatial light modulator based on the received photo-acoustic signal so that the irradiated electromagnetic wave with the modulated wavefront focuses on the position in the medium.

2. The apparatus according to claim 1, further comprising a second light source having different power than the electromagnetic wave source.

3. An apparatus comprising:
an irradiating unit, including an electromagnetic wave source which emits an electromagnetic wave, configured to irradiate a medium with the electromagnetic wave;
a spatial light modulator configured to modulate a wavefront of the electromagnetic wave;
an ultrasound device configured to apply ultrasound to a position of the medium where a frequency of the electromagnetic wave is shifted;
a detector configured to detect the electromagnetic wave whose frequency is shifted; and
a controller configured to control the spatial light modulator based on the detected electromagnetic wave so that the irradiated electromagnetic wave with the modulated wavefront focuses on the position in the medium.

4. An apparatus comprising:
a spatial light modulator configured to modulate a wavefront of an electromagnetic wave to be applied to a medium, by monitoring a first signal from the medium, so that the applied electromagnetic wave focuses on a position of the medium;
an applying unit configured to apply the electromagnetic wave with the modulated wavefront to the medium;
a detector configured to detect a second signal, which is of the same type as the first signal, from the position of the medium; and
an image generating unit configured to generate an image based on the detected second signal.

5. The apparatus according to claim 4, wherein the first and second signals are photo-acoustic signals.

6. The apparatus according to claim 4, wherein the first and second signals are acousto-optic signals.

7. An apparatus comprising:
a spatial light modulator configured to modulate a wavefront of an electromagnetic wave to be applied to a medium, by monitoring at least one of a photo-acoustic signal and an acousto-optic signal from the medium, so that the applied electromagnetic wave focuses on a position of the medium;
an applying unit configured to apply the electromagnetic wave with the modulated wavefront to the medium;
a first unit configured to detect the photo-acoustic signal from the position of the medium;
a second unit configured to detect the acousto-optic signal from the position of the medium; and
an image generating unit configured to generate an image based on the detected the photo-acoustic and the acousto-optic signals.
